(19) United States
(12) Patent Application Publication
(10) Pub. No.: US 2021/0151242 A1
(43) Pub. Date: May 20, 2021

(54) INDUCTOR COMPONENT AND METHOD FOR MANUFACTURING INDUCTOR COMPONENT

(71) Applicant: Panasonic Intellectual Property Management Co., Ltd., Osaka (JP)

(72) Inventors: MANABU SATOU, Hyogo (JP); HIDETOSHI HIWATASHI, Osaka (JP)

(21) Appl. No.: 16/624,313

(22) PCT Filed: Jul. 10, 2018
(86) PCT No.: PCT/JP2018/025965

§ 371 Date: Dec. 19, 2019

(30) Foreign Application Priority Data
Jul. 19, 2017 (JP) 2017-139631

(51) Int. Cl. H01F 27/28; H01F 17/04; H01F 27/29; H01F 27/30; H01F 41/10

(52) U.S. Cl. CPC H01F 27/2828; H01F 17/04; H01F 2017/048; H01F 27/306; H01F 41/10; H01F 27/292

(57) ABSTRACT

An inductor component includes coil portion that is formed by conducting wire being wounded, and has hollow portion in a winding axis direction, terminal electrodes that are made of metal plate, and serve as a pair of first terminal electrode and second terminal electrode connected to coil portion, and molded body that is made of a magnetic material of a soft magnetic powder and a resin, and has coil portion buried. The pair of terminal electrodes are disposed on the opposite side of each other through winding axis, the pair of terminal electrodes each have coil fixing portion that coil portion is fixed to, coil fixing portion integrally has erected portion adjacent to an inner periphery side of coil portion, and this erected portion has curved portion curved along the inner periphery side of coil portion when viewed from a winding axis direction.

### TECHNICAL FIELD

The present disclosure relates to an inductor component used for various electronic apparatuses, and a method for manufacturing the inductor component.

### BACKGROUND ART

Conventionally, an inductor component has been widely used, where a coil is sealed by a magnetic mold resin made of a magnetic powder and a resin.

As the above-described conventional inductor component, there has been suggested, for example, a mold coil described in Unexamined Japanese Patent Publication No. 2009-267350 (PTL 1).

A third exemplary embodiment (refer to paragraph numbers 0031 to 0039, FIGS. 9 to 10) suggested in this Unexamined Japanese Patent Publication No. 2009-267350 will be described.

In a method for manufacturing a mold coil, a supporter, a connector, and a leading portion are first formed in an external electrode made of a phosphor bronze plate.

Next, a conducting wire is wound to form an air-core coil. This air-core coil is placed on the supporter of the external electrode, and an end portion of the air-core coil and the connector of the external electrode are subjected to spot welding to form a coil member.

Next, a molding mold that molds this coil member is prepared.

The molding mold is made of an upper mold with an upper portion and a lower portion open, a lower mold with an upper portion open, and a punch that is inserted from an opening portion of the upper portion of the upper mold, and is capable of rising and falling vertically.

The upper mold and the lower mold are fitted together, and the punch is set in the opening portion of the upper portion of the upper mold to thereby form a cavity, and fitting the lower mold and the upper mold together allows a bottom portion of the cavity.

This lower mold is provided with a positioning pin in the bottom portion of the cavity, the positioning pin projecting upward from the bottom portion of the cavity and capable of rising and falling in a vertical direction of the cavity.

Next, in a step of molding the coil member, first, the coil member is disposed inside the cavity.

In the coil member, the leading portion of the external electrode is sandwiched between the upper mold and the lower mold, and further, the positioning pin is disposed so as to be inserted into a hollow portion of the air-core coil.

In this manner, the air-core coil is brought into a state where a horizontal direction inside the cavity is fixed by the positioning pin, and the air-core coil is hollow-held at a proper position by the supporter of the external electrode.

Next, the magnetic mold resin is put on the coil member inside the cavity from the opening portion of the upper mold, and a magnetic mold resin is melted by remaining heat of the molding mold.

Next, the punch is set in the opening portion of the upper mold, and a pressure of 3 kgf is applied for five seconds, using the punch.

Next, after the positioning pin is lowered up to a position of the bottom portion of the cavity, a pressure of 5 kgf is applied for 20 seconds, using the punch, and a portion where the positioning pin has been placed is filled with the magnetic mold resin.

Thereafter, application of the pressure from the punch is stopped, the magnetic mold resin is cured by heating and leaving the same, and a molded body is taken out from the molding mold.

It has been suggested that in this manner, the mold coil is obtained.

### CITATION LIST

### Patent Literature

PTL 1: Unexamined Japanese Patent Publication No. 2009-267350

### SUMMARY OF THE INVENTION

However, in the configuration of the conventional mold coil and the method for manufacturing the same, the structure where the positioning pin is provided in the molding mold for molding the coil, and the like are complicated, so that there has a problem that production efficiency becomes worse, because, for example, in the step of molding the coil, it is necessary to control the positioning pin and the punch in linkage.

The present disclosure is to solve the above-described problem, and an object thereof is to provide a configuration of an inductor component having improved production efficiency and a method for manufacturing the inductor component.

In order to achieve the above-described object, one aspect of the present disclosure includes a coil portion, a terminal electrode, and a molded body. The coil portion is formed by a conducting wire being wounded, and has a hollow portion in a winding axis. A first terminal electrode and a second terminal electrode are made of a metal plate to be connected to the coil portion and be connected to external circuits. A molded body is made of a magnetic material including a soft magnetic powder and a resin, and has the coil portion buried therein. The first terminal electrode and the second terminal electrode are disposed on an opposite side of each other through the winding axis in one surface of the coil portion in the winding axis direction. The first terminal electrode has a first coil fixing portion that one surface of the coil portion is fixed to. The second terminal electrode has a second coil fixing portion that the one surface of the coil portion is fixed to. The first coil fixing portion integrally has a first erected portion that is erected toward the winding axis to be made adjacent to an inner periphery side of the coil portion. The second coil fixing portion integrally has a second erected portion that is erected toward the winding axis to be made adjacent to the inner periphery side of the coil portion. The first erected portion and the second erected portion each have a curved portion that is curved along the inner periphery side of the coil portion when viewed from a winding axis direction.

Moreover, another aspect of the present disclosure includes the following steps. That is, the step of winding a conducting wire and forming a coil portion having a hollow portion in a winding axis direction is included. The step of, by subjecting a metal plate to press working, forming terminal electrodes that serve as a pair of a first terminal electrode and a second terminal electrode to be connected to the coil portion and be connected to external circuits is included. The step of fixing the coil portion to the terminal electrodes is included. The step of forming a molded body having the coil portion buried in a magnetic material made of a soft magnetic powder and a resin is included. In the step of forming the terminal electrodes, by subjecting the metal plate to blanking, the first terminal electrode and the second terminal electrode are disposed and formed on an opposite side of each other through the winding axis in one surface of the coil portion in the winding axis direction. In the first terminal electrode, a first coil fixing portion that fixes the one surface of the coil portion is formed. In the second terminal electrode, a second coil fixing portion that fixes the one surface of the coil portion is formed. In the first coil fixing portion, a first erection piece extended on the hollow portion side is formed. In the second coil fixing portion, a second erection piece extended on the hollow portion is formed. After this step, the step of, by subjecting the first erection piece and the second erection piece to erection working toward the winding axis side, forming a first erected portion and a second erected portion each having a curved portion that is made adjacent to an inner periphery side of the coil portion and is curved along the inner periphery side of the coil portion when viewed from the winding axis direction is included. In the step of fixing the coil portion to the terminal electrodes, by fitting the first erected portion and the second erected portion into the hollow portion of the coil portion, the coil portion is positioned and fixed to the terminal electrodes.

According to the one aspect of the present disclosure, the first terminal electrode has the first coil fixing portion that the one surface of the coil portion is fixed to. The second terminal electrode has the second coil fixing portion that the one surface of the coil portion is fixed to. The first coil fixing portion integrally has the first erected portion that is erected toward the winding axis side to be made adjacent to the inner periphery side of the coil portion. The second coil fixing portion integrally has the second erected portion that is erected toward the winding axis side to be made adjacent to the inner periphery side of the coil portion. The first erected portion and the second erected portion each have the curved portion that is curved along the inner periphery side of the coil portion when viewed from the winding axis direction.

Thereby, the first erected portion and the second erected portion each having the curved portion that is curved along the inner periphery side of the coil portion can make the positioning of the coil portion easy, and thus, an effect that production efficiency of the inductor component can be increased can be obtained.

According to the other aspect of the present disclosure, in the step of forming the terminal electrodes, by subjecting the metal plate to the blanking, the first terminal electrode and the second terminal electrode are disposed and formed on the opposite position to each other through the winding axis in the one surface of the coil portion in the winding axis direction. In the first terminal electrode, the first coil fixing portion that fixes the one surface of the coil portion is formed. In the second terminal electrode, the second coil fixing portion that fixes the one surface of the coil portion is formed. In the first coil fixing portion, the first erection piece extended on the hollow portion side is formed. In the second coil fixing portion, the second erection piece extended on the hollow portion side is formed. After this step, the step of, by subjecting the first erection piece and the second erection piece to erection working toward the winding axis, forming the first erected portion and the second erected portion each having the curved portion that is made adjacent to the inner periphery side of the coil portion and is curved along the inner periphery side of the coil portion when viewed from the winding axis direction is included. In the step of fixing the coil portion to the terminal electrodes, by fitting the first erected portion and the second erected portion into the hollow portion of the coil portion, the coil portion is positioned and fixed to the terminal electrodes.

Thereby, only fitting the first erected portion and the second erected portion into the hollow portion of the coil portion can make the positioning of the coil portion easy, and thus, an effect that production efficiency of the inductor component can be increased can be obtained.

### BRIEF DESCRIPTION OF DRAWINGS

FIG. 1 is a perspective view of a bottom surface side of an inductor component in one exemplary embodiment of the present disclosure.

FIG. 2 is a perspective view of a top surface side of the inductor component in the one exemplary embodiment of the present disclosure.

FIG. 3 is a transparent perspective view of the bottom surface side of the inductor component in the one exemplary embodiment of the present disclosure.

FIG. 4 is a transparent perspective view of the top surface side of the inductor component in the one exemplary embodiment of the present disclosure.

FIG. 5 is a view for describing a manufacturing step of the inductor component in the one exemplary embodiment of the present disclosure.

FIG. 6 is a view for describing a manufacturing step of the inductor component in the one exemplary embodiment of the present disclosure.

FIG. 7 is a view for describing a manufacturing step of the inductor component in the one exemplary embodiment of the present disclosure.

FIG. 8 is a view for describing a manufacturing step of the inductor component in the one exemplary embodiment of the present disclosure.

FIG. 9 is a view for describing a manufacturing step of the inductor component in the one exemplary embodiment of the present disclosure.

FIG. 10 is a view for describing a manufacturing step of the inductor component in the one exemplary embodiment of the present disclosure.

FIG. 11 is a view for describing a manufacturing step of the inductor component in the one exemplary embodiment of the present disclosure.

FIG. 12 is a view for describing a manufacturing step of the inductor component in the one exemplary embodiment of the present disclosure.

FIG. 13 is a top view of a lower mold of a molding mold for manufacturing the inductor component in the one exemplary embodiment of the present disclosure.

FIG. 14 is an enlarged view of an A portion in FIG. 13.

FIG. 15A is a view before filling with a magnetic material.

FIG. 15B is a view during the filling with the magnetic material.

FIG. 15C is a view when the filling with the magnetic material has been completed.

FIG. 16 is an enlarged view of a C portion in FIG. 15A.

FIG. 17 is a view for describing a manufacturing step of the inductor component in the one exemplary embodiment of the present disclosure.

### DESCRIPTION OF EMBODIMENT

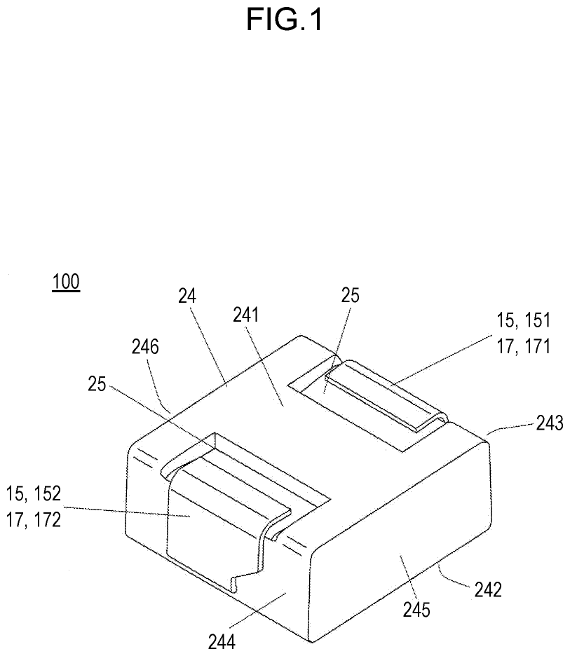

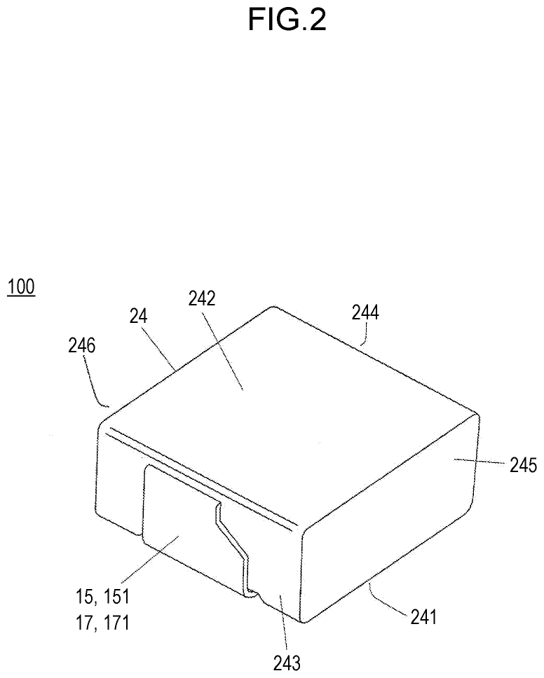

Hereinafter, an inductor component in one exemplary embodiment of the present disclosure will now be described with reference to FIGS. 1 to 4.

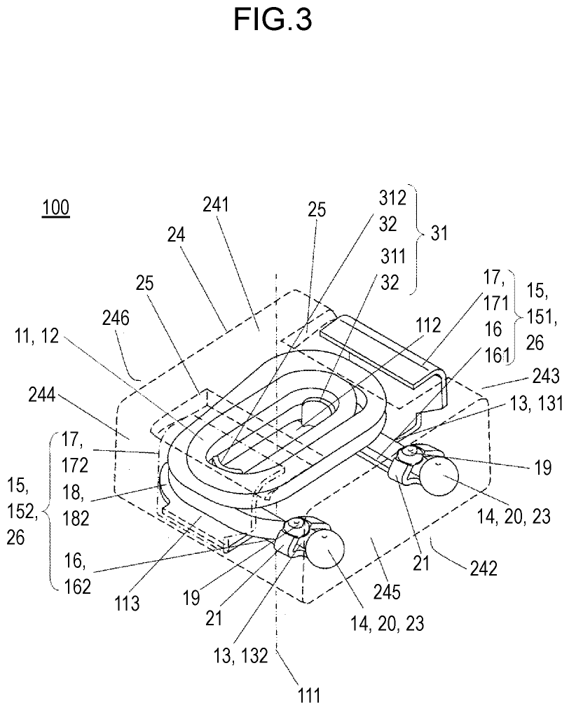

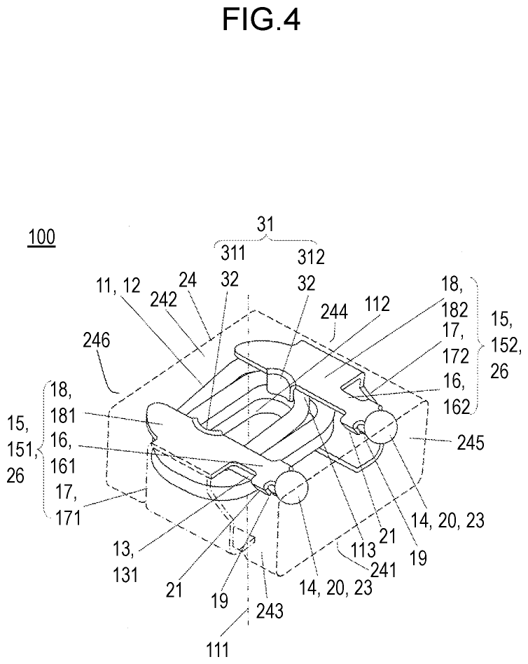

FIGS. 3, 4 are each a transparent perspective view where molded body 24 described later is transmitted, and a contour of molded body 24 is indicated by broken line.

Furthermore, in order to facilitate understanding in FIGS. 3, 4, external terminal portion 17 on a front side in the drawings of a pair of external terminal portions 17 described later is shown in a transparent manner, and a contour thereof is indicated by alternate long and short dashed line.

As shown in FIGS. 1 to 4, inductor component 100 of the present exemplary embodiment includes coil portion 11 resulting from a winding conducting wire 12 with an insulating film, and leading portions 13 that have the insulating films at both end portions of conducting wire 12 removed, and are led out in an external direction of coil portion 11. Moreover, inductor component 100 includes a pair of terminal electrodes 15 made of metal plate 26, and each having connecting wire portion 16 that leading portion 13 is connected to, coil fixing portion 18 that joins to the connecting wire portion 16 and coil portion 11 is fixed to, and external terminal portion 17 that joins to coil fixing portion 18 to be connected to an external circuit.

Inductor component 100 of a coil-buried type is configured where coil portion 11, leading portions 13, and connecting wire portions 16 are buried in molded body 24 made of a soft magnetic powder and a resin, a part of each of external terminal portions 17 is exposed from the molded body 24, and coil portion 11 is buried in molded body 24 made of a magnetic material.

Of these portions, molded body 24 is molded, for example, by mixing a pulverized FeSiCrB based alloy by an atomization method, and an epoxy resin.

Molded body 24 has a square cylindrical shape having bottom surface 241, top surface 242 on the opposite side of bottom surface 241, first side surface 243 joining bottom surface 241 and top surface 242, second side surface 244 on the opposite side of first side surface 243, third side surface 245 joining first side surface 243 and second side surface 244, and fourth side surface 246 on the opposite side of third side surface 245.

The shape of molded body 24 is not limited to the square cylindrical shape, but, for example, may be a pentagonal cylindrical shape or a circular cylindrical shape.

Coil portion 11 is a coil having an air core formed by winding conducting wire 12 with the insulating film of polyamide-imide or the like so that a shape of a winding core is a long circular shape.

Coil portion 11 has hollow portion 112 in a direction of winding axis 111 (indicated by long dashed double-short dashed line in FIGS. 3, 4). This hollow portion 112 is filled with the magnetic material at the time of formation of molded body 24.

A shape of hollow portion 112 is formed in accordance with the shape of the winding core, and the shape of the winding core is not limited to the long circular shape, but may be circular or elliptical.

Coil portion 11 is disposed in a direction connecting bottom surface 241 and top surface 242 of molded body 24 (a vertical direction in FIG. 3) in the winding axis 111.

Moreover, coil portion 11 is disposed so that a longitudinal direction of coil portion 11 formed by being wound into a long circular shape is a direction connecting first side surface 243 and second side surface 244.

As to a diameter dimension of a cross section of conducting wire 12 forming this coil portion 11, in the case of a small inductor component having dimensions of molded body 24 in planar view equivalent to, for example, 4 mm×4 mm, a thin conducting wire having a diameter dimension of about 0.1 mm to 0.3 mm is used to form coil portion 11 by winding the same.

In the case of thin conducting wire 12, it is desirable that the shape of coil portion 11 be maintained by a welded layer, using conducting wire 12 with the welded layer on a surface.

Leading portions 13 serve as a pair of first leading portion 131 and second leading portion 132 at both ends of conducting wire 12 of coil portion 11.

First leading portion 131 and second leading portion 132 are each led out in the external direction of coil portion 11 when coil portion 11 is viewed in plane from the direction of the winding axis 111 (direction when coil portion 11 is viewed from the upper side of the drawing in FIG. 3).

The insulating film of conducting wire 12 of the led-out portion is peeled and removed.

In an example shown in FIGS. 1 to 4, first leading portion 131 and second leading portion 132 are led out in the same direction as a lateral direction of coil portion 11, and are led out toward a direction of third side surface 245 of molded body 24.

Terminal electrodes 15 are made of a metal plate of phosphor bronze, pure copper or the like having a thickness of 0.1 mm, and each have connecting wire portion 16 that leading portion 13 is connected to, coil fixing portion 18 that joins to connecting wire portion 16 to fix coil portion 11, and external terminal portion 17 that joins to coil fixing portion 18 to be connected to the external circuit.

These connecting wire portion 16 and coil fixing portion 18, and external terminal portion 17 are formed integrally.

Terminal electrodes 15 serve as a pair of first terminal electrode 151 and second terminal electrode 152 disposed on the opposite side of each other through winding axis 111 in one surface 113 of coil portion 11 in the winding axis 111 direction.

Here, the disposition on the opposite side of each other with winding axis 111 means that first terminal electrode 151 and second terminal electrode 152 are disposed at an interval on both sides of winding axis 111.

First terminal electrode 151 has first connecting wire portion 161 that first leading portion 131 is connected to, first coil fixing portion 181 that joins to first connecting wire portion 161, and one surface 113 of coil portion 11 in the winding axis 111 direction is fixed to, and first external terminal portion 171 that joins to first coil fixing portion 181 to be connected to the external circuit.

Moreover, second terminal electrode 152 has second connecting wire portion 162 that second leading portion 132 is connected to, second coil fixing portion 182 that joins to second connecting wire portion 162, and one surface 113 of coil portion 11 in the winding axis 111 direction is fixed to, and second external terminal portion 172 that joins to second coil fixing portion 182 to be connected to the external circuit.

The pair of external terminal portions 17 made of first external terminal portion 171 and second external terminal portion 172 is worked in accordance with a form of the connection to the external circuits.

In the example shown in FIGS. 1 to 4, in the external terminal portions 17, first external terminal portion 171 is projected and exposed from first side surface 243 of molded body 24. Moreover, second external terminal portion 172 is projected and exposed from second side surface 244 of molded body 24.

First external terminal portion 171 is bent from first side surface 243 of molded body 24 toward bottom surface 241, and second external terminal portion 172 is bent from second side surface 244 toward bottom surface 241 to be disposed in containing depressed portions 25 that each contain external terminal portion 17, and be worked into external terminal portion 17 of a surface mounting type, containing depressed portions 25 being formed in bottom surface 241 of molded body 24.

Connecting wire portions 16 serve as a pair of first connecting wire portion 161 having a shape extended along first leading portion 131, and second leading wire portion 162 having a shape extended along second leading portion 132.

First connecting wire portion 161 has a pair of first joint pieces 21 between coil portion 11 and terminal 14 of first leading portion 131, the pair of first joint pieces 21 being extended in opposite directions so as to leave each other from both sides of first connecting wire portion 161.

In each of this pair of first joint pieces 21, a leading end side thereof is bent toward an opposite side of first connecting wire portion 161 in first leading portion 131.

First connecting wire portion 161 has first joint portion 19 resulting from melting and jointing a portion in first leading portion 131 on the opposite side of connecting wire portion 16, and leading portions of first joint pieces 21 to connect them.

Furthermore, first connecting wire portion 161 has second joint portion 20 resulting from melting and jointing terminal 14 of first leading portion 131 and first connecting wire portion 161 to make into melted ball 23.

Similarly to first connecting wire portion 161, second connecting wire portion 162 also has first joint pieces 21, first joint portion 19 and second joint portion 20 connected to second leading portion 132.

Thus, each of connecting wire portions 16 has connection portions of first joint portion 19 and second joint portion 20 that leading portion 13 is connected to at the two positions, and this can restrain leading portion 13 from coming off from connecting wire portion 16 while the two connection portions compensate for each other, and can increase connection strength.

Coil fixing portions 18 serve as a pair of first coil fixing portion 181 and second coil fixing portion 182.

These coil fixing portions 18 are each formed into a shape along a part of the shape of coil portion 11, and one surface 113 of coil portion 11 in the winding axis 111 direction is fixed by adhesive 27 or the like (not shown in FIGS. 1 to 4).

In the example shown in FIGS. 3, 4, in coil portion 11 formed into a long circular shape, first coil fixing portion 181 has a shape along a portion along in a lateral direction on a first side surface 243 side of molded body 24, and second coil fixing portion 182 has a shape along a portion in the lateral direction on a second side surface 244 side of molded body 24.

In addition, first coil fixing portion 181 integrally has first erected portion 311 that is erected toward the winding axis 111 side to be made adjacent to an inner periphery side of coil portion 11.

Moreover, second coil fixing portion 182 integrally has second erected portion 312 that is erected toward the winding axis 111 side to be made adjacent to the inner periphery side of coil portion 11 on the opposite side of first erected portion 311 through winding axis 111 of coil portion 11.

Furthermore, these first erected portion 311 and second erected portion 312 each have curved portion 32 that is curved along the inner periphery side of coil portion 11 when viewed from the winding axis 111 direction.

In the example shown in FIGS. 3, 4, each of curved portions 32 has a shape along a curve of a lateral portion of coil portion 11 formed into a long circular shape.

This lateral portion has a semicircular shape, and curved portion 32 is along a semicircular curve.

Curved portion 32 may be along a part of the semicircular shape of the lateral portion, or may be along all of the semicircular shape.

In this manner, first erected portion 311 and second erected portion 312 are each erected into a shape having curved portion 32 from first coil fixing portion 181 and second coil fixing portion 182, and this can increase strength of first erected portion 311 and second erected portion 312, as compared with a case where they are each simply erected into a linear shape.

According to the present exemplary embodiment, with the above-described configuration, since first erected portion 311 and second erected portion 312 are erected on the winding axis 111 side of coil portion 11, and are adjacent to the inner periphery side of coil portion 11, positioning of coil portion 11 can be easily performed.

Moreover, since first erected portion 311 and second erected portion 312 regulate a position of coil portion 11, the fluctuation in the position of coil portion 11 can be restrained from fluctuating after the positioning of coil portion 11.

Since first erected portion 311 and second erected portion 312 each have the shape having curved portion 32 that is curved along the inner periphery side of coil portion 11 when viewed from the winding axis 111 direction, coil portion 11 can be positioned more accurately than in the case where they are each formed into a linear shape.

Furthermore, first erected portion 311 and second erected portion 312 each have curved portion 32, and this can increase strength of first erected portion 311 and second erected portion 312.

This increase of first erected portion 311 and second erected portion 312 can suppress deformation of first erected portion 311 and second erected portion 312 by a molding pressure when molded body 24 is formed, and can suppress the fluctuation of the position of coil portion 11.

From these results, inductor component 100 of the present exemplary embodiment can bring about an effect that since the positioning of the coil can be easily performed, and the position of coil portion 11 can also be restrained from fluctuating, no positioning pin is required, and the structure and the control can be simplified, so that the production efficiency of inductor component 100 can be increased, as compared with the molding mold described in the conventional mold coil.

In the present exemplary embodiment, also, it is also possible that first erected portion 311 and second erected portion 312 are disposed at line symmetrical positions with respect to a straight line passing winding axis 111, and that first erected portion 311 and second erected portion 312 are confronted with each other, when viewed from the winding axis 111 direction.

Since this allows first erected portion 311 and second erected portion 312 to be disposed with good balance with respect to coil portion 11, coil portion 11 can be positioned more accurately.

Moreover, the molding pressure applied to coil portion 11 when molded body 24 is molded is distributed to first erected portion 311 and second erected portion 312 with good balance, so that positional fluctuation of coil portion 11 by the molding pressure of molded body 24 can be more suppressed.

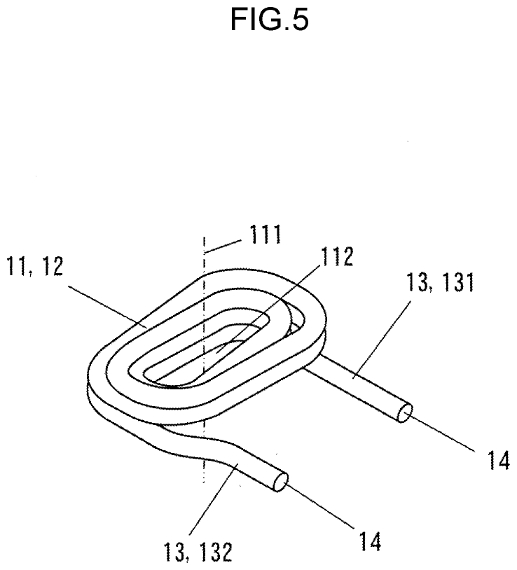

Next, a method for manufacturing inductor component 100 of the above-described present exemplary embodiment will now be described with reference to FIGS. 5 to 17.

FIGS. 5 to 17 are views for describing manufacturing steps of inductor component 100 in the one exemplary embodiment of the present invention.

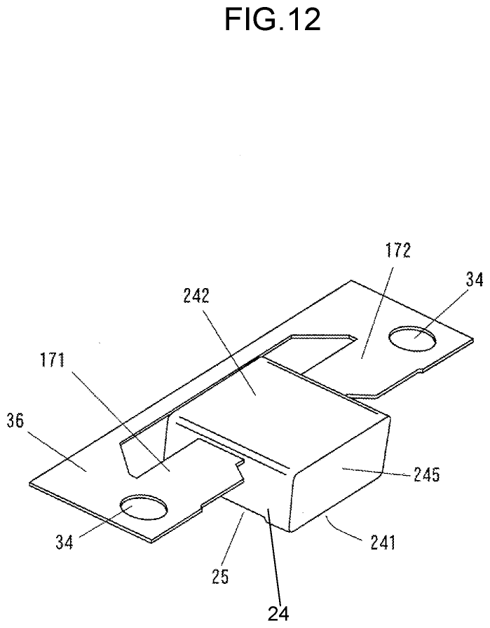

In FIGS. 5 to 11, and 17, a side of bottom surface 241 of inductor component 100 is shown on an upper side of the drawings. In FIG. 12, a side of top surface 242 is shown on an upper side of the drawing.

First, as shown in FIG. 5, conducting wire 12 of pure copper with the insulating film is wound to form coil portion 11, conducting wire 12 having a circular cross-sectional shape. Conducting wire 12 with a welded layer on a surface of the insulating film is used.

Coil portion 11 is wound so that a shape on the inner periphery side is a long circular shape when viewed from the direction of winding axis 111.

Both the end portions of conducting wire 12 are led out in the external directions of coil portion 11 to form leading portions 13 serving as the pair of first leading portion 131 and second leading portion 132.

In portions connected to connecting wire portions 16 of leading portions 13, the insulating films are removed in advance.

These first leading portion 131 and second leading portion 132 are led out in the same direction as the lateral direction of coil portion 11. In the example shown in FIG. 3, first leading portion 131 and second leading portion 132 are led out in the direction of third side surface 245 of molded body 24.

Moreover, coil portion 11 maintains the shape by causing the welded layer to react.

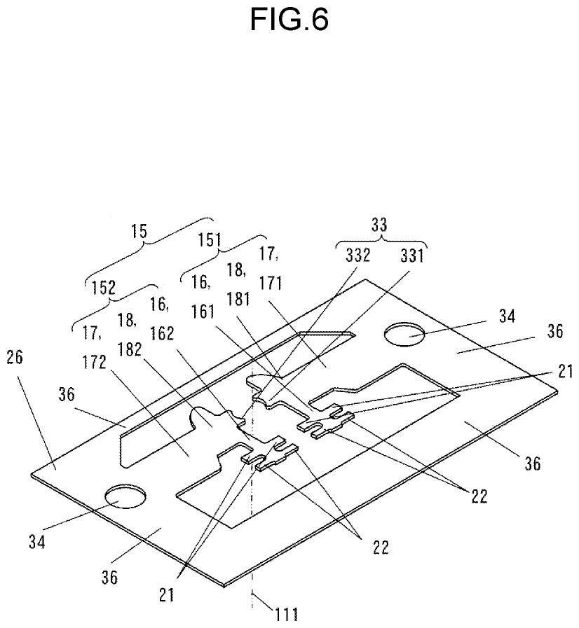

Next, as shown in FIG. 6, terminal electrodes 15 are formed by subjecting metal plate 26 to blanking.

Terminal electrodes 15 are formed by subjecting metal plate 26 to the blanking, metal plate 26 being a hoop material made of phosphor bronze or pure copper, and having a thickness of 0.1 mm.

Terminal electrodes 15 are disposed on the opposite side of each other through winding axis 111 in one surface 113 of coil portion 11 in the winding axis 111 direction, and serve as the pair of first terminal electrode 151 and second terminal electrode 152.

First terminal electrode 151 integrally forms first connecting wire portion 161 for connecting first leading portion 131, first coil fixing portion 181 for joining to first connecting wire portion 161 and fixing one surface 113 of coil portion 11, and first external terminal portion 171 for joining to first coil fixing portion 181 to be connected to the external circuit.

Moreover, second terminal electrode 152 integrally forms second connecting wire portion 162 for connecting second leading portion 132, second coil fixing portion 182 for joining to second connecting wire portion 162 and fixing one surface 113 of coil portion 11, and second external terminal portion 172 for joining to second coil fixing portion 182 to be connected to the external circuit.

Of these, first external terminal portion 171 and second external terminal portion 172 of external terminal portions 17 are extended on the opposite direction to each other, and are connected to joining portion 36 of the hoop material.

In this manner, first terminal electrode 151 and second terminal electrode 152 are integrated by the hoop material.

In joining portion 36 of the hoop material, pilot holes 34 are formed and are used for conveyance or positioning in subsequent steps.

Connecting wire portions 16 serve as the pair of first connecting wire portion 161 having a shape extended along first leading portion 131, and second connecting wire portion 162 having a shape extended along second leading portion 132.

First connecting wire portion 161 has the pair of first joint pieces 21 at a position corresponding to a section between coil portion 11 and terminal 14 of first leading portion 131, the pair of first joint pieces 21 being extended in the opposite directions so as to leave each other from both the sides of first connecting wire portion 161.

Furthermore, a pair of second joint pieces 22 are integrally formed, the pair of second joint pieces 22 being extended in opposite directions so as to leave each other from both the sides of first connecting wire portion 161 at an interval of first joint pieces 21 on a terminal 14 side of first leading portion 131.

In an example shown in FIG. 6, first joint pieces 21 and second joint pieces 22 are formed in directions perpendicular to an extension direction of first connecting wire portion 161.

Moreover, in second connecting wire portion 162, similarly to first connecting wire portion 161, first joint pieces 21 and second joint pieces 22 are also formed.

Coil fixing portions 18 serve as first coil fixing portion 181 and second coil fixing portion 182.

These coil fixing portions 18 are each formed into a shape along a shape of a part of the shape of coil portion 11.

In the example shown in FIG. 6, first coil fixing portion 181 has the shape along the portion in the lateral direction on the first side surface 243 side of molded body 24 in coil portion 11 formed into the long circular shape, and second coil fixing portion 182 has the shape along the portion in the lateral direction on the second side surface 244 side of molded body 24.

Moreover, coil fixing portions 18 are formed with a pair of erection pieces 33 extended on a hollow portion 112 side of coil portion 11.

Erection pieces 33 serve as a pair of first erection piece 331 extended on the hollow portion 112 side from first coil fixing portion 181, and second erection piece 332 extended on the hollow portion 112 side from second coil fixing portion 182.

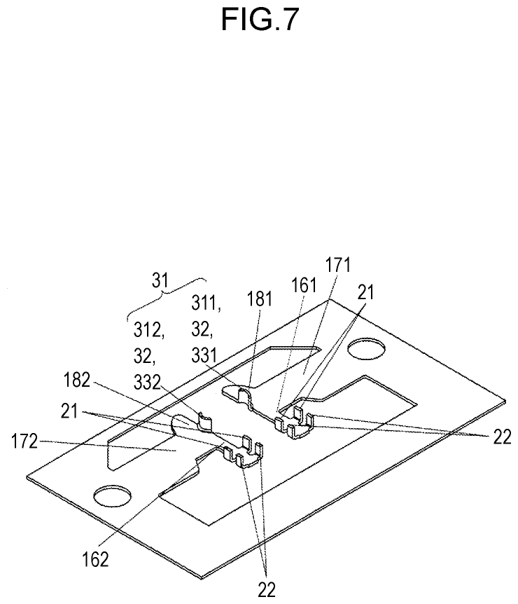

Next, as shown in FIG. 7, first erection piece 331 and second erection piece 332 are erected toward the winding axis 111 side.

Erection working can be performed by performing burring.

In the burring, first, there are prepared an upper die mold (not shown) and a lower die mold (not shown) having a through hole in a similar shape to the shape of hollow portion 112 when viewed from the winding axis 111 direction of coil portion 11, and a punch (not shown) formed into a similar shape obtained by subtracting a thickness dimension of metal plate 26 from the through hole of the upper die mold and the lower die mold.

This through hole is formed into a similar shape equivalent to, or reduced from hollow portion 112 of coil portion 11 and is prepared. The through hole is formed so that the shape of the through hole includes a shape of a curved portion on the inner periphery side of coil portion 11.

First terminal electrode 151 and second terminal electrode 152 are sandwiched between the upper die mold and the lower die mold so that first erection piece 331 and second erection piece 332 are projected into the through hole, and the punch is pushed in a direction corresponding to hollow portion 112 of coil portion 11 to perform working for erecting first erection piece 331 and second erection piece 332.

While the through hole of the upper die mold and the lower die mold may have the same dimensions as those of hollow portion 112 of coil portion 11, in a step of fixing coil portion 11 to terminal electrodes 15, which step will be described later, each clearance when first erected portion 311 and second erected portion 312 are fitted into hollow portion 112 of coil portion 11 may be reduced and formed smaller than hollow portion 112.

By performing the erection working in this manner, first erection piece 331 is made adjacent to the first side surface 243 side on the inner periphery side of coil portion 11, and is worked into first erected portion 311 having curved portion 32 curved along the inner periphery side of coil portion 11 when viewed from the winding axis 111 direction.

Moreover, second erection piece 332 is made adjacent to the second side surface 244 side on the inner periphery side of coil portion 11, and is worked into second erected portion 312 having curved portion 32 curved along the inner periphery side of coil portion 11 when viewed from the winding axis 111 direction.

First erected portion 311 and second erected portion 312 are confronted and erected to configure a pair of erected portions 31.

A leading end side of the hollow portion 112 side of each of first erection piece 331 and second erection piece 332 shown in FIG. 6 is preferably formed into a similar shape curved along the inner periphery side of coil portion 11.

This can makes it easy to maintain a height of an upper end portion of each of first erected portion 311 and second erected portion 312 constant when they are worked.

Moreover, in this step, a leading end side of each of the pair of first joint pieces 21 and the pair of second joint pieces 22 is bent and erected at an angle of about 90° toward a side where leading portions 13 are disposed (an upper side of the drawing in FIG. 7).

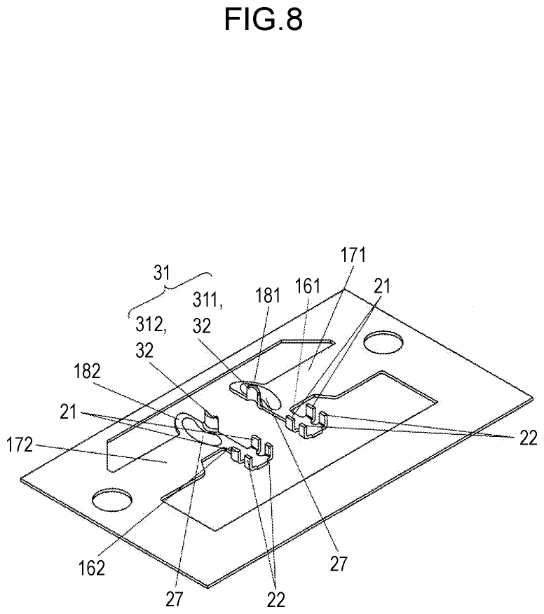

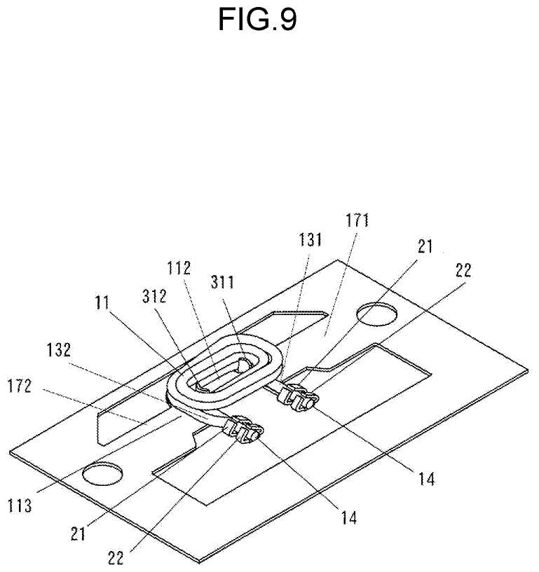

Next, as shown in FIG. 8, adhesive 27 is applied to coil fixing portion 18, and then, as shown in FIG. 9, coil portion 11 is fixed to terminal electrodes 15.

As to the fixing of coil portion 11 to terminal electrodes 15, by fitting first erected portion 311 and second erected portion 312 into hollow portion 112 of coil portion 11, coil portion 11 is positioned and placed in first coil fixing portion 181 and second coil fixing portion 182 of terminal electrodes 15, and adhesive 27 is cured to fix the coil portion 11.

Thus, an erection height dimension of first erected portion 311 and second erected portion 312 from first coil fixing portion 181, and second coil fixing portion 182 is preferably a diameter dimension of conducting wire 12 or more, and a height dimension of coil portion 11 in the winding axis 111 direction or less.

It is not preferable that the erection height dimension be smaller than the diameter dimension of conducting wire 12, because the positioning of coil portion 11 easily becomes unstable, and it is not preferable that the erection height dimension be larger than the height dimension in the winding axis direction of coil portion 11, because first erected portion 311 and second erected portion 312 stick out from an upper end of the coil portion, so that the molding pressure when molded body 24 is formed is easily received.

Moreover, in this step, as shown in FIG. 9, the respective leading end sides of the pair of first joint pieces 21 and the second joint pieces 22 are bent so as to be turned back toward the opposite side of the connecting wire portion 16 in each of the leading portions 13, and the leading end sides of first joint pieces 21 and second joint pieces 22 are brought into contact with leading portion 13, and the leading portion 13 is locked to the connecting wire portion 16.

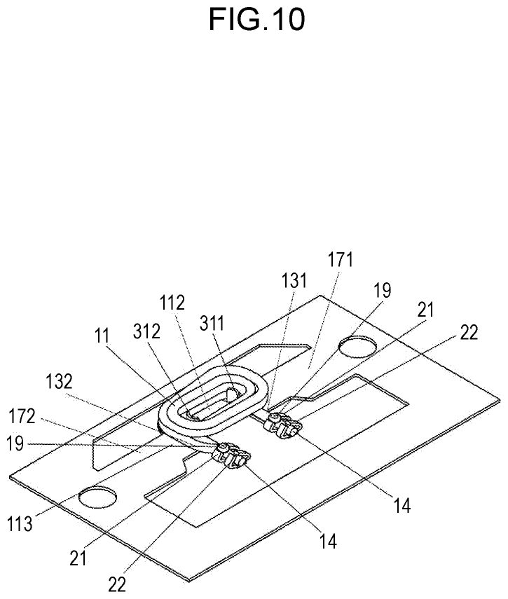

Next, as shown in FIG. 10, portions of leading portions 13 on the opposite side of the connecting wire portions 16, and leading end portions of the pairs of first joint pieces 21 are partially melted and jointed by laser welding to be connected, so that first joint portions 19 are formed.

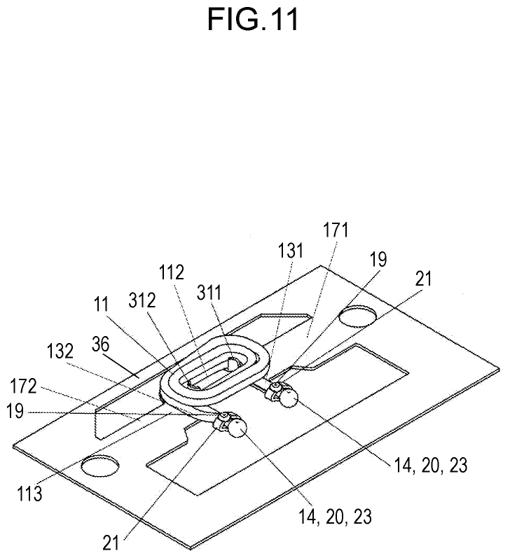

Next, as shown in FIG. 11, after first joint portions 19 are formed, terminals 14 of leading portions 13, and connecting wire portions 16 including second joint pieces 22 are melted by laser welding to be jointed, and second joint portions 20 are formed, second joint portions being made into melted balls 23 from terminals 14 of leading portions 13 and connecting wire portions 16 including second joint pieces 22.

At this time, a heat quantity of the laser welding that forms each of the second joint portions 20 is larger than a heat quantity when each of first joint portions 19 is formed.

However, by forming second joint portions 20 after forming first joint portions 19, heat when second joint portions 20 are formed is released from first joint portions 19 formed in advance to joining portion 36 of the hoop material through first joint pieces 21 and connecting wire portions 16, and thus, deterioration of the insulating films of conducting wire 12 can be suppressed.

When connection strength between terminal 14 of leading portion 13 and connecting wire portion 16 is sufficiently large, second joint pieces 22 may not be provided.

Next, as shown in FIG. 12, molded body 24 is formed, molded body 24 having coil portion 11 buried in the magnetic material made of the soft magnetic powder and the resin.

As the magnetic material, for example, a magnetic material obtained by mixing a pulverized FeSiCrB based alloy by an atomization method, and epoxy resin is used.

In FIG. 12, top surface 242 of molded body 24 is shown on an upper side of the drawing.

Molded body 24 is formed by disposing and fixing coil portion 11, leading portions 13, connecting wire portions 16, and coil fixing portions 18 in the cavity of the molding mold except for a part of external terminal portions 17 of terminal electrodes 15, and filling the cavity with the magnetic material melted.

In the present exemplary embodiment, while the molding mold is not particularly limited, molding mold 38, which will be described next, can be used, and it is preferable because the use of this molding mold 38 can more increase the production efficiency of inductor component 100.

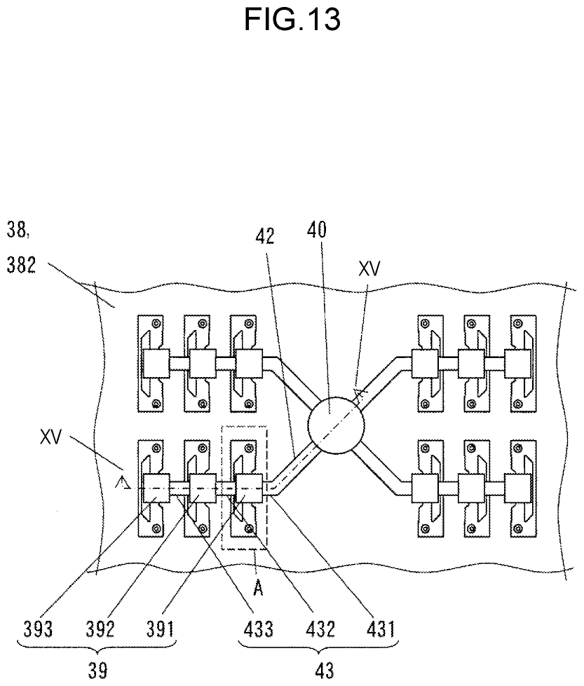

This molding mold 38 will be described with reference to FIGS. 13 to 16.

FIG. 13 is a top view of the lower mold of the molding mold of the inductor component in one exemplary embodiment of the present invention.

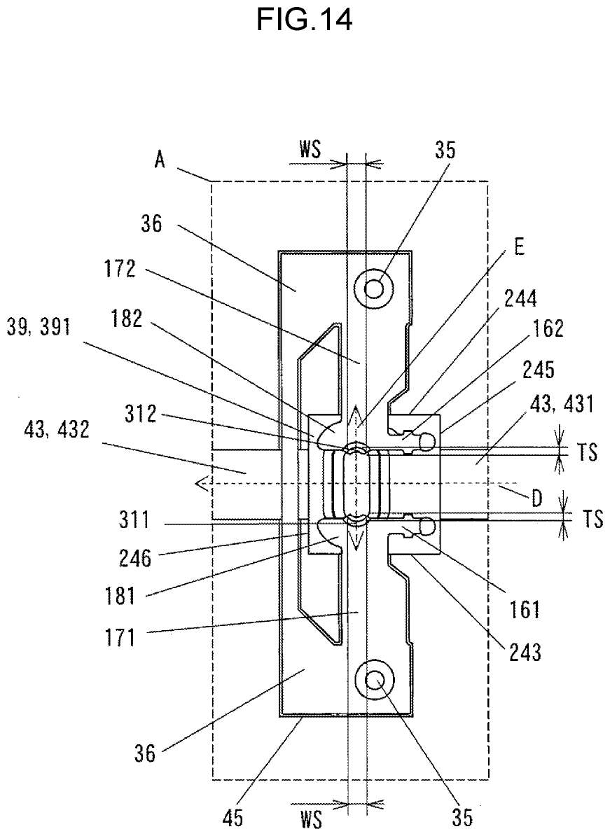

FIG. 14 is an enlarged view of an A portion in FIG. 13, and a state where coil portion 11, leading portions 13, connecting wire portions 16, and coil fixing portions 18, which are not shown, are disposed inside the cavity is shown. Coil portion 11, leading portions 13, connecting wire portions 16, and coil fixing portions 18 are shown in FIG. 4.

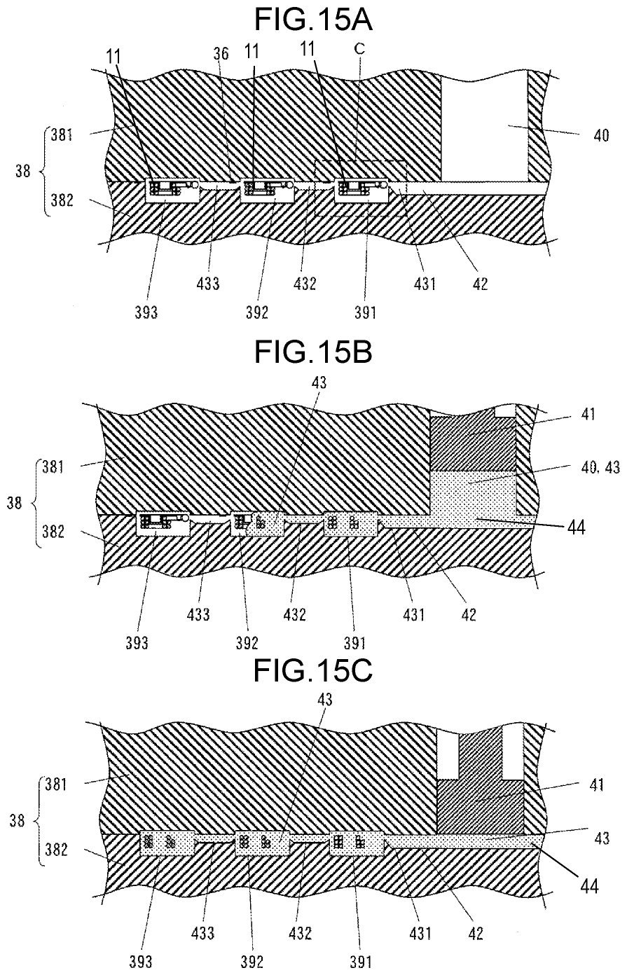

FIGS. 15A to 15C show a molding step of molded body 24, and show a cross-sectional portion along XV-XV line in FIG. 13.

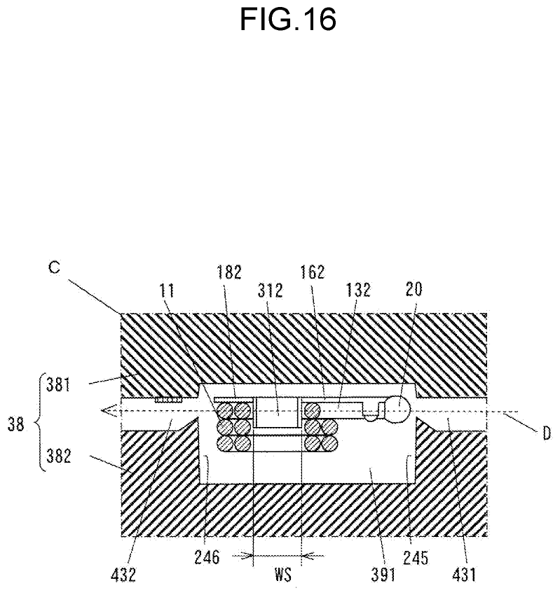

In FIGS. 15A to 15C, FIG. 15A is a view before filling magnetic material 44, FIG. 15B is a view during filling with magnetic material 44, and FIG. 15C is a view of filling completion of magnetic material 44. FIG. 16 shows an enlarged view of a C portion in FIG. 15A.

Molding mold 38 is configured by fitting split molds of fitting upper mold 381 and lower mold 382 together.

As molding mold 38, a molding mold is prepared, the molding mold including pot 40 for pressing and supplying magnetic material 44 melted, plunger 41 for pressing magnetic material 44 melted inside pot 40, runners 42 connected to pot 40, and a plurality of cavities 39 linearly connected in series to a forefront of each of runners 42 through gates 43.

By pressing magnetic material 44 inside pot 40 with plunger 41, magnetic material 44 is transferred to cavities 39 to fill the same.

In an example shown in FIG. 13, four independent runners 42 are connected to one pot 40, first gate 431 is provided at a leading end of each of runners 42, and first cavity 391 is disposed in connection to this first gate 431.

On a forefront side of first cavity 391, that is, on a downstream side at the time of transfer of magnetic material 44 melted, second gate 432 is provided, and second cavity 392 is disposed in connection to this second gate 432.

Furthermore, on the downstream side of second cavity 392, third cavity 393 is connected through third gate 433, so that three cavities 39 are linearly connected in series through gates 43.

In this manner, the plurality of cavities 39 are linearly connected in series through gates 43, and thereby, magnetic material 44 discarded after filling runners 42 for molding can be reduced, so that use efficiency of magnetic material 44 can be increased, as compared with in a case where independent runners are connected to the plurality of cavities, respectively.

In this case, as shown in FIG. 12, a part of metal plate 26 of the hoop material on the third side surface 245 side of molded body 24 is preferably cut or the like to make intervals of the plurality of cavities 39 small, so that the use efficiency of magnetic material 44 can be more increased.

Next, a state where leading portions 13, connecting wire portions 16 and coil fixing portions 18 are disposed and fixed to cavities 39 of above-described molding mold 38 will be described.

As shown in FIGS. 14, 16, external terminal portions 17 and joining portion 36 of the hoop material are sandwiched and fixed between upper mold 381 and lower mold 382 to dispose and fix coil portion 11, leading portions 13, connecting wire portions 16, and coil fixing portions 18 in cavities 39.

In lower mold 382, step portion 45 that external terminal portions 17 and joining portion 36 of the hoop material are fitted into is formed, and pilot pins 35 that position pilot holes 34 of the hoop material are provided.

At this time, coil portion 11 is disposed so that a direction connecting the plurality of cavities 39 (indicated by broken line arrow D in FIG. 14), and a direction connecting first erected portion 311 and second erected portion 312 (indicated by broken line arrow E in FIG. 14) are substantially perpendicular.

Here, substantially perpendicular disposition means that an angle where the direction connecting the plurality of cavities 39, and the direction connecting first erected portion 311 and second erected portion 312 cross each other is not limited to only 90°, but variation on production when joining portion 36 of the hoop material and external terminal portion 17 are positioned are included, and a range of 85° to 95° is preferable.

In the example shown in FIG. 14, in first cavity 391, first gate 431 on the upstream side of first cavity 391 is formed on the third side surface 245 side of molded body 24, second gate 432 on the downstream side of first cavity 391 is formed in fourth side surface 246 of molded body 24, and the direction connecting the plurality of cavities 39 is a direction connecting third side surface 245 and fourth side surface 246.

The example is described where the direction connecting first erected portion 311 and second erected portion 312 is a direction connecting first side surface 243 and second side surface 244 of molded body 24.

Next, a step of molding molded body 24, using molding mold 38 will be described with reference to FIGS. 15A to 15C.

First, as shown in FIG. 15A, coil portion 11 is disposed and fixed to each of first cavity 391, second cavity 392, and third cavity 393, as described before.

Next, as shown in FIG. 15B, magnetic material 44 melted is put into pot 40, and is pressed by plunger 41 to be transferred into a flow passage of molding mold 38.

In FIG. 15B, magnetic material 44 passes runner 42, first gate 431, first cavity 391, and second gate 432 from pot 40, and is transferred to second cavity 392.

Next, as shown in FIG. 15C, further, magnetic material 44 is pressed by plunger 41, and passes third gate 433 downstream from second cavity 392, the filling of third cavity 393 at a terminal with magnetic material 44 is completed, and the pressing of plunger 41 is stopped.

Thereafter, by heating molding mold 38, the epoxy resin of magnetic material 44 is heat-cured, and runners 42, and gates 43 are removed to obtain molded body 24.

Moreover, in this step, as needed, containing depressed portions 25 that contain external terminal portions 17 in bottom surface 241 of molded body 24 are formed in advance.

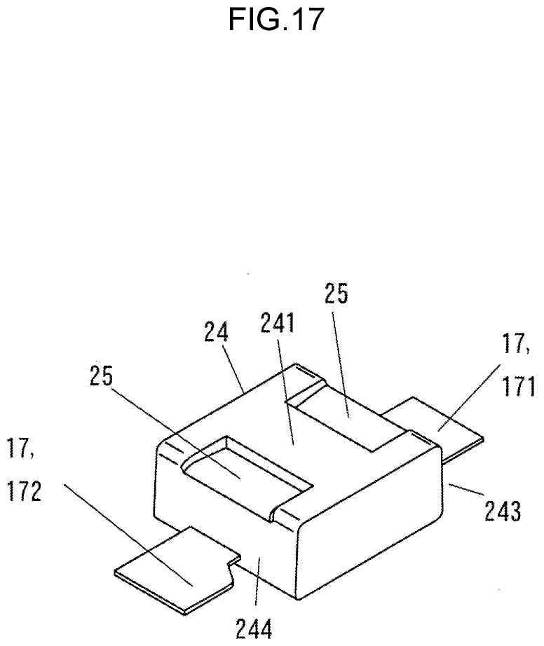

Next, as shown in FIG. 17, external terminal portions 17 are each cut at a predetermined length, and as needed, plating such as solder or the like is applied to external terminal portions 17.

Finally, external terminal portions 17 are bent from first side surface 243 and second side surface 244 of molded body 24 toward bottom surface 241, and external terminal portions 17 are disposed in containing depressed portions 25 formed in bottom surface 241 of molded body 24, and thereby, inductor component 100 of coil-buried type shown in FIGS. 1 to 4 can be obtained.

According to the above-described method for manufacturing the inductor component of the present exemplary embodiment, in the step of forming terminal electrodes 15, the following step is performed; by subjecting metal plate 26 to blanking, first terminal electrode 151 and second terminal electrode 152 are disposed and formed in one surface 113 of coil portion 11 in the winding axis 111 direction so as to be opposite to each other through winding axis 111. In first terminal electrode 151, first coil fixing portion 181 that fixes one surface 113 of coil portion 11 is formed. In second terminal electrode 152, second coil fixing portion 182 that fixes one surface 113 of coil portion 11 is formed. In first coil fixing portion 181, first erection piece 331 extended on the hollow portion 112 side is formed. In addition, in second coil fixing portion 182, second erection piece 332 extended on the hollow portion 112 side is formed. After this step, the step is provided where first erection piece 331 and second erection piece 332 are subjected to erection working toward the winding axis 111 side, and thereby first erected portion 311 and second erected portion 312 having curved portions 32 are formed, the curved portions being adjacent to the inner periphery side of coil portion 11, and being curved along the inner periphery side of coil portion 11 when viewed from the winding axis 111 direction.

Furthermore, the step of fixing of coil portion 11 to terminal electrodes 15 includes the step of, by fitting first erected portion 311 and second erected portion 312 into hollow portion 112 of coil portion 11, positioning and fixing coil portion 11 to terminal electrodes 15.

This enables first erected portion 311 and second erected portion 312 made adjacent to the inner periphery side of coil portion 11 to be formed, so that only fitting first erected portion 311 and second erected portion 312 into hollow portion 112 of coil portion 11 enables coil portion 11 to be easily positioned and fixed to terminal electrodes 15.

Moreover, since first erected portion 311 and second erected portion 312 regulate the position of coil portion 11, the position of coil portion 11 can be restrained from fluctuating after the positioning of coil portion 11.

Since first erected portion 311 and second erected portion 312 each have the shape having curved portion 32 that is curved along the inner periphery side of coil portion 11 when viewed from the winding axis 111 direction, coil portion 11 can be positioned more accurately than in the case where they are formed into a linear shape.

Furthermore, first erected portion 311 and second erected portion 312 each have curved portion 32, and thereby, strength of first erected portion 311 and second erected portion 312 can be increased.

In this case, roots of first erected portion 311 and second erected portion 312 are preferably put into regions of first coil fixing portion 181 and second coil fixing portion 182, as shown in FIG. 7, and thereby, the strength of first erected portion 311 and second erected portion 312 can be more increased.

The increase in strength of first erected portion 311 and second erected portion 312 can suppress deformation of first erected portion 311 and second erected portion 312 due to the molding pressure when molded body 24 is formed, and can more restrain the position of coil portion 11 from fluctuating.

From these results, the method for manufacturing inductor component 100 of the present exemplary embodiment can bring about effects that since the positioning of the coil portion 11 can be easily performed, and the position of coil portion 11 when molded body 24 is formed can also be restrained from fluctuating, no positioning pin is required, and the structure and the control can be simplified, so that the production efficiency of inductor component 100 can be increased, as compare with the molding mold described in the conventional mold coil.

In the present exemplary embodiment, when viewed from the winding axis 111 direction, first erected portion 311 and second erected portion 312 can also be disposed at line symmetrical positions with respect to the straight line passing winding axis 111, and first erected portion 311 and second erected portion 312 can also be confronted with each other.

Since this allows first erected portion 311 and second erected portion 312 to be disposed with good balance with respect to coil portion 11, coil portion 11 can be positioned more accurately.

The molding pressure applied to coil portion 11 when molded body 24 is molded is distributed to first erected portion 311 and second erected portion 312 with good balance, so that the fluctuation of coil portion 11 can be easily suppressed.

Furthermore, in the present exemplary embodiment, in the step of forming molded body 24, molding mold 38 is used, the molding mold 38 including pot 40 for pressing and supplying magnetic material 44 melted, runners 42 connected to pot 40, and the plurality of cavities 39 linearly connected in series to the forefront of each of runners 42 through gates 43. By pressing magnetic material 44 inside pot 40 by plunger 41, magnetic material 44 is transferred to cavities 39, and the direction connecting the plurality of cavities 39 and the direction connecting first erected portion 311 and second erected portion 312 can also be substantially perpendicular to each other.

This can increase the use efficiency of magnetic material 44, and can increase the production efficiency of inductor component 100, as described before.

Moreover, in this case, the direction connecting the plurality of cavities 39, that is, the direction where magnetic material 44 passes through cavities 39, and the direction connecting first erected portion 311 and second erected portion 312 can be substantially perpendicular to each other.

This allows the molding pressure received by coil portion 11 to be distributed to first erected portion 311 and second erected portion 312 with good balance, so that fluctuation of the position of coil portion 11 can be prevented due to deformation of first erected portion 311 and second erected portion 312.

Furthermore, in this case, in each of first erected portion 311 and second erected portion 312, a dimension in the direction perpendicular to the direction where these first erected portion 311 and second erected portion 312 are confronted (indicated by WS in FIG. 14) can be larger than a dimension in the direction where first erected portion 311 and second erected portion 312 are confronted (indicated by TS in FIG. 14).

In this manner, since by satisfying TS<WS, WS along the direction where magnetic material 44 flows is made larger against the molding pressure when magnetic material 44 passes through cavities 39, the strength of first erected portion 311 and second erected portion 312 can be more increased.

Furthermore, in this case, it is preferable that the direction where first leading portion 131 and second leading portion 132 are led out, which is shown in FIG. 11, match the direction connecting the plurality of cavities 39 shown in FIG. 14.

This can make it hard for first leading portion 131 and second leading portion 132 to receive the molding pressure when magnetic material 44 passes through cavities 39, and as a result, the position of coil portion 11 can be restrained from fluctuating.

### INDUSTRIAL APPLICABILITY

The configuration of the inductor component and the method for manufacturing the same according to the present disclosure can increase the production efficiency of the inductor component, and is industrially useful.

### REFERENCE MARKS IN THE DRAWINGS

11 coil portion
111 winding axis
112 hollow portion
113 one surface
12 conducting wire
13 leading portion
131 first leading portion
132 second leading portion
14 terminal
15 terminal electrode
151 first terminal electrode
152 second terminal electrode
16 connecting wire portion
161 first connecting wire portion
162 second connecting wire portion
17 external terminal portion
171 first external terminal portion
172 second external terminal portion
18 coil fixing portion
181 first coil fixing portion
182 second coil fixing portion
19 first joint portion
20 second joint portion
21 first joint piece
22 second joint piece
23 melted ball
24 molded body
241 bottom surface
242 top surface
243 first side surface
244 second side surface
245 third side surface
246 fourth side surface
25 containing depressed portion
26 metal plate
27 adhesive
31 erected portion
311 first erected portion
312 second erected portion
32 curved portion
33 erection piece
331 first erection piece
332 second erection piece
34 pilot hole
35 pilot pin
36 joining portion
38 molding mold
381 upper mold
382 lower mold
39 cavity
391 first cavity
392 second cavity
393 third cavity
40 pot
41 plunger
42 runner
43 gate
431 first gate
432 second gate
433 third gate
44 magnetic material
45 step portion
100 inductor component

1. An inductor component comprising:
a coil portion that is formed by a conducting wire being wounded around a winding axis, and has a hollow portion in the winding axis;
a first terminal electrode and a second terminal electrode that are comprised of a metal plate, to be connected to the coil portion and to be connected to external circuits; and
a molded body that is comprised of a magnetic material including a soft magnetic powder and a resin, and has the coil portion buried,
wherein the first terminal electrode and the second terminal electrode are disposed on one surface of the coil portion to oppose each other via the winding axis, the one surface being perpendicular to the winding axis,
the first terminal electrode has a first coil fixing portion that the one surface of the coil portion is fixed to,
the second terminal electrode has a second coil fixing portion that the one surface of the coil portion is fixed to,
the first coil fixing portion integrally has a first erected portion that is erected along the winding axis to be comprised adjacent to an inner periphery side of the coil portion,
the second coil fixing portion integrally has a second erected portion that is erected along the winding axis to be comprised adjacent to the inner periphery side of the coil portion, and
the first erected portion and the second erected portion each have a curved portion that is curved along the inner periphery side of the coil portion when viewed from the winding axis direction.

2. The inductor component according to claim 1, wherein the first erected portion and the second erected portion are disposed in line symmetry with respect to a straight line including the winding axis, and the first erected portion and the second erected portion are confronted when viewed from the winding axis direction.

3. A method for manufacturing an inductor component, comprising the steps of:
winding a conducting wire and forming a coil portion having a hollow portion in a winding axis direction;
by subjecting a metal plate to press working, forming terminal electrodes that serve as a pair of a first terminal electrode and a second terminal electrode to be connected to the coil portion and be connected to external circuits;
fixing the coil portion to the terminal electrodes; and
forming a molded body having the coil portion buried in a magnetic material comprised of a soft magnetic powder and a resin,
wherein the step of forming the terminal electrodes has the steps of:
by subjecting the metal plate to blanking, disposing and forming the first terminal electrode and the second terminal electrode on an opposite side of each other through a winding axis in one surface of the coil portion in the winding axis direction, forming a first coil fixing portion in the first terminal electrode, the first coil fixing portion configured to fix the one surface of the coil portion, forming a second coil fixing portion in the second terminal electrode, the second coil fixing portion configured to fix the one surface of the coil portion, forming a first erection piece in the first coil fixing portion, the first erection piece extended on the hollow portion side, and forming a second erection piece in the second coil portion, the second erection piece extended on the hollow portion;
by subsequently subjecting the first erection piece and the second erection piece to erection working toward the winding axis side, forming a first erected portion and a second erected portion each having a curved portion that is comprised adjacent to an inner periphery side of the coil portion and is curved along when viewed from the winding axis direction, and
the step of fixing the coil portion to the terminal electrodes has a step of:
by fitting the first erected portion and the second erected portion into the hollow portion of the coil portion, positioning and fixing the coil portion to the terminal electrodes.

4. The method for manufacturing the inductor component according to claim 3, wherein the first erected portion and the second erected portion are disposed in line symmetry with respect to a straight line including the winding axis, and the first erected portion and the second erected portion are confronted when view from the winding axis direction.

5. The method for manufacturing the inductor component according to claim 4, wherein the step of forming the molded body is a step of, by pressing the magnetic material inside a pot by a plunger, using a molding mold including the pot for pressing and supplying the magnetic material melted, a runner connected to the pot, and a plurality of cavities linearly connected in series through gates in a forefront of the runner, transferring the magnetic material to the cavities, and a direction connecting the plurality of cavities and a direction connecting the first erected portion and the second erected portion are perpendicular to each other.

6. The method for manufacturing the inductor component according to claim 5, wherein in each of the first erected portion and the second erected portion, a dimension in a direction perpendicular to a direction where the first erected portion and the second erected portion are confronted is larger than a dimension in the direction where the first erected portion and the second erected portion are confronted.
